(19) United States
(12) Patent Application Publication
(10) Pub. No.: US 2010/0289824 A1
(43) Pub. Date: Nov. 18, 2010

(54) Virtual Keyboard and Onscreen Keyboard

(75) Inventor: Jack Atzmon, Englewood, NJ (US)

Correspondence Address: COHEN, PONTANI, LIEBERMAN & PAVANE LLP, 551 FIFTH AVENUE, SUITE 1210, NEW YORK, NY, 10176, US

(73) Assignee: Ergowerx Internationakl LLC, Englewood, NJ (US)

(21) Appl. No.: 12/811,580

(22) PCT Filed: Jan. 5, 2009
(86) PCT No.: PCT/US09/00023

§ 371 Date: Jul. 2, 2010

Related U.S. Application Data
(60) Provisional application No. 61/019,064, filed on Jan. 4, 2008.

(51) Int. Cl. G09G 5/00; G06F 3/041

(52) U.S. Cl. 345/647; 345/204; 345/173

(57) ABSTRACT

A device having a display and a display controller. The display controller is configured to vary a layout of a displayed keyboard such that a biomechanical relationship between the device and a user of the device is changed.

### CROSS REFERENCE

This application claims priority to U.S. Application No. 61/019,064 filed Jan. 4, 2008, the contents of which is incorporated herein by reference

### BACKGROUND OF THE INVENTION

1. Field of the Invention

The present invention relates to virtual or onscreen keyboards, and more particularly to a virtual or onscreen keyboard, that periodically or continuously alters its shape.

2. Description of the Related Art

Many devices incorporate keyboards. For example, many cellular telephones and personal digital assistants (PDA) incorporate standard QWERTY keyboards. These devices have either a physical keyboard made up of small, physical keys or a virtual keyboard displayed on a display screen of the device. The displayed keyboard is typically embodied as a touchscreen keyboard.

The known onscreen keyboard is context sensitive. In other words, the keys that are displayed change depending on the application. The known onscreen keyboard has hot zones plus predictive text. A predictive text engine determines what words are being typed, and then magnifies the hot zone around the next most likely key.

### SUMMARY OF THE INVENTION

Among the limitations of present onscreen or virtual keyboards is that during use, the keys do not require the user to change his or her biomechanical relationship with the device.

An object of the present invention is to provide a virtual or onscreen keyboard that alters its shape. The disclosed keyboard is configured to programmatically reposition itself to vary the biomechanical relationship between the device and the user.

### BRIEF DESCRIPTION OF THE DRAWINGS

Further features and advantages of the invention are specified below accompanied by descriptions of exemplary embodiments and with reference to the figures in the drawing. In said drawing:

FIG. 1 is a device having a virtual onscreen keyboard;

FIG. 2 is the device of FIG. 1 after a shape alteration; and

FIG. 3 is a block diagram of the device.

### DETAILED DESCRIPTION OF THE PRESENTLY PREFERRED EMBODIMENTS

The present disclosure is related to an onscreen or virtual keyboard. An onscreen keyboard is typically a touch sensitive keyboard for a cellular telephone, FDA, tablet computer, or the like and a virtual keyboard is typically a projected data entry keyboard for a heads-up display, or the like, that relies on positional sensors for input.

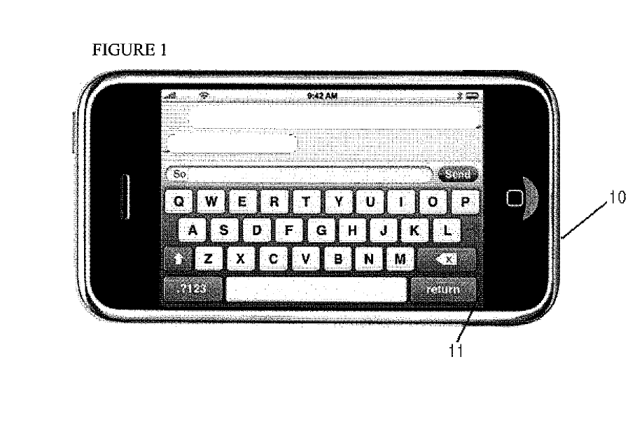

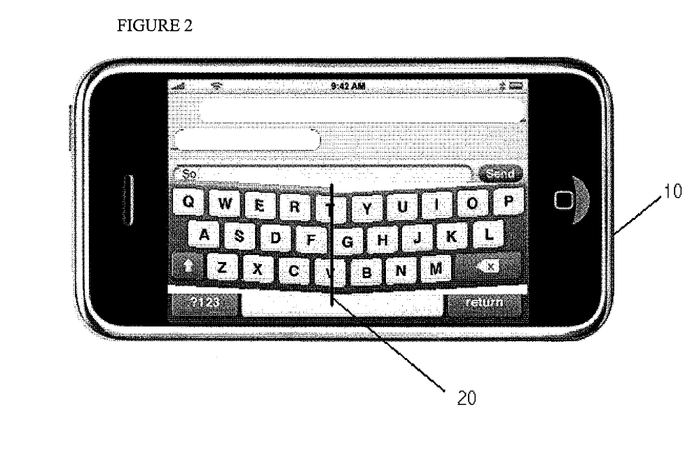

Such keyboards are configured to alter their shape such that the biomechanical relationship between the keyboard and the user is altered. The keyboard, whether virtual or onscreen, would preferably change its shape from a substantially straight-line configuration for the keys, as shown in FIG. 1, to an alternate key configuration such as V-shaped, as shown in FIG. 2, an inverted V-shape, a concave shape, a concave shape, or a combination thereof. The keyboard is adapted to vary within a potentially infinite number of angles and/or radii. It should be noted that whereas the onscreen keyboard can only move in two dimensions, the virtual keyboard is adapted to move in up to three dimensions.

The present invention is adapted to work with any keyboards including QWERTY, Dvorak, number pads, and the like. In a preferred embodiment, the keyboard is divided into a plurality of zones. Each zone is configured to move either independent of the other zones or in conjunction with the motion of another zone. In the case of a miniature keyboard adapted for use with a user's thumbs, in addition to the above mentioned motion, the portions of the keyboard also separate in a lateral direction.

The zones of the keyboard would change due to a time in use, pattern of keystrokes, workload, temperature, or exhibit random motion. It should be noted that the overall key layout and key relationships, such as a QWERTY keyboard, do not change. The keyboard layout preferably varies between ergonomically comfortable positions. Preferably, each change in at least one of the spacing and position of the keyboard keys is slight and causes the user to reposition his or her hands. This repositioning of the user's hands preferably avoids repetitive stress injuries (RSI) such as carpal tunnel syndrome.

FIG. 1 is a typical device incorporating an onscreen keyboard. As shown, the device 10 has a display 11. As shown, the display includes a standard QWERTY keyboard in landscape mode. The principles of the invention are equally applicable to a portrait display. The keyboard is shown in the unadjusted mode.

FIG. 2 depicts the device 10 after the keyboard has been adjusted. As depicted, the keyboard has moved so that the keys are V-shaped. However, it should be noted that any alternate key arrangement is possible. The keys move about symmetry line 20. While line 20 is shown bisecting the landscape display, the line 20 can be perpendicular to its present orientation. Additionally, the key zones can be varied from those shown. Alternatively, the keyboard is divided into a plurality of subportions, not shown, which vary in position.

In a preferred embodiment, existing devices can be updated via a software update such that the existing keyboards are replaced with the positionally variable keyboard disclosed herein. The software, adapted to run on a microprocessor of the device, controls the display of the device. Additionally, the software receives as an input, the data input via the touchscreen. This data is correlated with the known key position to determine the selected key. The software can be downloaded via a server or installed via a recordable medium.

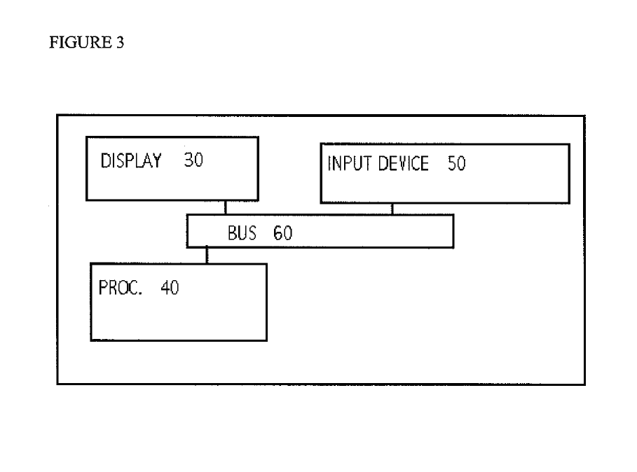

FIG. 3 is a block diagram of the device. As shown, a microprocessor 40 is coupled to a bus 60. Also coupled to the bus 60 is a display 30 and an input device 50. Input device 50 can be a wireless input, a smart card, a memory card, or the like. In a preferred embodiment, the display 30 includes touchscreen functionality. In one embodiment, the device includes a thermosensitive display. In that embodiment, the key positions are varied base on temperature differentials on the touchscreen caused by use.

When a user is interacting with the portable communication device, one of a plurality of functions starts that monitors user interaction with the onscreen or virtual keyboard. Based at least in part on one of time, pressure, keystrokes, temperature, or the like, the display of the keyboard will change, thereby causing the user to change the biomechanical relationship with the device. The keyboard display will change in predetermined or random patterns. It should be noted that the patterns do not change the overall key relationships. In other words, adjacent keys are not repositioned so that touch-typing is not affected once the user adjusts the biomechanical relationship.

The present invention may be described herein in terms of functional block components, code listings, optional selections, and various processing steps. It should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices.

Similarly, the software elements of the present invention may be implemented with any programming or scripting language such as C, C++, C#, Java, COBOL, assembler, PERL, or the like, with the various algorithms being implemented with any combination of data structures, objects, processes, routines or other programming elements.

Further, it should be noted that the present invention may employ any number of conventional techniques for data transmission, signaling, data processing, network control, and the like.

It should be appreciated that the particular implementations shown and described herein are illustrative of the invention and its best mode and are not intended to otherwise limit the scope of the present invention in any way. Indeed, for the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical or virtual couplings between the various elements. It should be noted that many alternative or additional functional relationships or physical or virtual connections may be present in a practical electronic data communications system.

As will be appreciated by one of ordinary skill in the art, the present invention may be embodied as a method, a data processing system, a device for data processing, and/or a computer program product. Accordingly, the present invention may take the form of an entirely software embodiment, an entirely hardware embodiment, or an embodiment combining aspects of both software and hardware. Furthermore, the present invention may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The present invention is described below with reference to block diagrams and flowchart illustrations of methods, apparatus (e.g., systems), and computer program products according to various aspects of the invention. It will be understood that each functional block of the block diagrams and the flowchart illustrations, and combinations of functional blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems that perform the specified functions or steps, or suitable combinations of special purpose hardware and computer instructions.

One skilled in the art will also appreciate that, for security reasons, any databases, systems, or components of the present invention may consist of any combination of databases or components at a single location or at multiple locations, wherein each database or system includes any of various suitable security features, such as firewalls, access codes, encryption, de-encryption, compression, decompression, and/or the like.

A recording media storing a program for accomplishing the above mentioned apparatus maybe accomplished by programming functions of the above mentioned apparatuses with a programming language readable by a computer or processor, and recording the program on a media such as mentioned above.

A server equipped with a hard disk drive may be employed as a recording media. It is also possible to accomplish the present invention by storing the above mentioned computer program on such a hard disk in a server and reading the computer program by other computers through a network.

As a computer-processing device, any suitable device for performing computations in accordance with a computer program may be used. Examples of such devices include a personal computer, a laptop computer, a microprocessor, a programmable logic device, or an application specific integrated circuit.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps, which perform substantially the same function in substantially the same way to achieve the same results, are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A device comprising;
a display; and
a display controller configured to control the display,
wherein the display controller is configured to vary a layout of a displayed keyboard such that a biomechanical relationship between the device and a user of the device is changed without a physical repositioning of the display or physical modification of the device.

2. The device according to claim 1, wherein the display is a touchscreen display.

3. The device according to claim 2, wherein the displayed keyboard layout is varied in at least one of a V-shaped pattern, a convex pattern, and a concave pattern.

4. The device according to claim 3, wherein the pattern is symmetric about a line of symmetry.

5. The device according to claim 3, wherein the pattern is asymmetric about a line of symmetry.

6. The device according to claim 3, wherein the pattern is varied in response to at least one of keystrokes, program usage, temperature, and time.

7. The device according to claim 4, wherein the portions of the displayed keyboard separate from each other along the line of symmetry.

8. The device according to claim 4, wherein the displayed keyboard is divided into a plurality of portions and each of the plural portions are repositioned on the display.

9. The device according to claim 8, wherein each of the plural displayed portions of the keyboard are moved on the display relative to one another.

10. The device according to claim 8, wherein each of the plural displayed portions of the keyboard are moved on the display without considering a position of any other of the plural portions of the displayed keyboard.

11. The device according to claim 1, wherein the display is a virtual display.

12. A method of displaying a keyboard, comprising:
displaying a keyboard in a first display mode; and
displaying the keyboard in a second display mode,
wherein changing from the first display mode to the second display mode causes a user to vary a biomechanical relationship to use the displayed keyboard, and
wherein the change from the first display mode to the display second mode is based at least in part on one of time used, cumulative keystrokes, and temperature.

13. The device according to claim 12, wherein the keyboard is displayed on a touchscreen display.

14. The device according to claim 13, wherein the second display mode is V-shaped with respect to the first display mode.

15. The device according to claim 14, wherein the second display mode is V-shaped about a line of symmetry.

16. The device according to claim 13, wherein the second display mode is at least one of concave and convex with respect to the first display mode.

17. The device according to claim 1, wherein the display is a virtual display.

18. The device according to claim 13, wherein the second display mode displays portions of the keyboard moved on the display relative to the first display mode.
